(19) United States
(12) Patent Application Publication
(10) Pub. No.: US 2017/0210001 A1
(43) Pub. Date: Jul. 27, 2017

(54) KNIFE AND BLADE

(71) Applicant: MOZART AG, Solingen (DE)

(72) Inventor: Christoph WAHL, Solingen (DE)

(21) Appl. No.: 15/329,777

(22) PCT Filed: May 26, 2015
(86) PCT No.: PCT/EP2015/061553

§ 371 Date: Jan. 27, 2017

(30) Foreign Application Priority Data
Jul. 29, 2014 (DE) 10 2014 110 745.4

(51) Int. Cl. B25G 3/26; B21D 53/64; B26B 9/00; B21D 53/70

(52) U.S. Cl. CPC B25G 3/26; B21D 53/70; B21D 53/64; B26B 9/00

(57) ABSTRACT

The invention relates to a knife, comprising a blade holder and a blade having a blade plane, wherein the blade is arranged in such a way that the blade is retained in the blade holder at two points spaced apart from each other, i.e., a first point and a second point. In order to compensate hardening distortion that occurs when the blade is hardened, according to the invention the blade is retained in a non-displaceable manner at the first point and displaceably in a displacement direction at the second point with respect to the blade plane, wherein the shortest distance of the displacement direction going through the second point from the first point is greater than zero.

### FIELD OF THE INVENTION

The invention concerns a knife having a blade receiving means and a blade having a blade plane, wherein the blade is arranged held in the blade receiving means at two mutually spaced points, that is to say a first point and a second point. The invention further concerns a blade for a knife.

### BACKGROUND

A problem with knives having such a blade receiving means is that the blade is to be fixed in the blade receiving means with as little play as possible so that in use of the knife the blade does not “wobble” in the blade receiving means, that is to say move relative to the blade receiving means. The greater the amount of play, the correspondingly less secure and inaccurate the cut can become and the risk to the user can be correspondingly greater. Usual flat blades with a blade plane are produced by being stamped out with any openings and profile that may be provided, from a strip or sheet, and then hardened. As a consequence of the hardening process, so-called hardening distortion usually occurs which, as inter alia it can be a multiple of usual blade tolerances, has to be taken into account in arranging the points with optional fixing means. That step of compensating for hardening distortion can be only inadequately implemented in the context of the blade tolerances as it is generally over-sized by a multiple in order to minimize the rejection rate of blades. The consequence of this is that such blades are then “wobbly” at least in relation to the blade plane, that is to say they are disposed in the blade receiving means with a large play.

WO 9855273 A1 describes a knife of the general kind set forth, having a blade and a blade receiving means, wherein the blade has two slots which are aligned in the cutting direction and through which two projections which are congruent in shape in respect of cross-section engage perpendicularly to the blade plane. That admittedly provides for an improved fit of the blade in the blade receiving means, but it does not solve the problem of hardening distortion.

U.S. Pat. No. 4,005,525 and US 2010/0269348 A1 each disclose a knife of the general kind set forth in which the blade is held in the blade receiving means by three or four projections. That also provides for an improved fit for the blade in the blade receiving means but the problem of hardening distortion is not solved.

### SUMMARY

An object of the invention is to provide a knife of the general kind set forth in which the problem of hardening distortion is solved, without the risk that the blade moves in the blade plane in the blade receiving means relative to the latter. In addition, the invention seeks to provide that the nature and/or structure of the holding configuration are as uncomplicated as possible.

According to the invention that object is attained by a knife having a blade receiving means (2) and a blade (3) having a blade plane (E), wherein the blade (3) is arranged held in the blade receiving means (2) at two mutually spaced points, that is to say a first point (P1) and a second point (P2), characterised in that the blade (3) is held with respect to the blade plane (E) non-displaceably at the first point (P1) and displaceably in a displacement direction (v) at the second point (P2), wherein the shortest spacing (a) of the displacement direction (v) passing through the second point (P2) relative to the first point (P1) is greater than zero. Advantageous developments are described in the appendant claims.

The specified object is already attained in that the blade is held with respect to the blade plane non-displaceably at the first point and displaceably in a displacement direction at the second point, wherein the shortest spacing of the displacement direction passing through the second point relative to the first point is greater than zero. The statement that the shortest spacing of the displacement direction passing through the second point relative to the first point is greater than zero means that that displacement direction which passes through the second point does not extend through the first point, and that the first point is not on a straight line which contains the displacement direction or that the two points are not disposed on a common straight line which contains the displacement direction.

The blade is fixed in position non-displaceably in the first point in the blade receiving means. In the second point relative displacement of the blade and the blade receiving means in the displacement direction is allowed whereby length compensation can be effected to compensate for hardness distortion in the displacement direction. In other words, distortion of the blade due to the hardening operation and also possible dimensional tolerances of the blade and/or the blade receiving means can be compensated.

In addition the blade has a fixed fit in the blade receiving means. In that case the blade is mounted to the blade receiving means at the second point non-displaceably relative to a direction perpendicular to the displacement direction. Accordingly the blade is held in the blade receiving means, with the formation of a fixed lever arm extending between the first point and the second point of the blade receiving means. With the first point as a pivot point for the blade, a torque is transmitted by way of the lever with a lever force to the blade, the lever force acting on the second point perpendicularly to the lever arm. As the shortest spacing of the displacement direction passing through the second point relative to the first point is greater than zero a force component of the lever force acts perpendicularly to the displacement direction and thus in the direction in which the blade is held non-displaceably. This means that the blade is held non-rotatably with respect to the first point. Accordingly the dimensions of the blade and the blade receiving means or the relative position of the two points on the blade and the blade receiving means can thus be implemented in conforming relationship in the blade and the blade receiving means respectively in such a way that the blade can be fitted play-free in the blade receiving means at the two points.

In addition the way in which the object of the invention is attained proposes a very simple structure involving only two points, in which the blade is mounted in the blade receiving means.

Hardening distortion generally occurs in the hardening operation by virtue of the fact that, to ensure that a blade strip from which the blades are later stamped out passes correctly through a hardening furnace the blade strip is held under tension. As a consequence of the annealing temperatures in the hardening furnace the blade strip is predominantly axially deformed, that is to say in the direction of the applied tensile force. When producing high-grade blades production tolerances of a few 1/100ths of a millimeter are admittedly certainly usual while the distortion due to hardening of the blades can be in the region of 1/10th of a millimeter, that is to say about 10 times the production tolerances. However hardening distortion can have the result that the blade has an insecure fit in a usual blade receiving means or even cannot be properly fitted into the blade receiving means.

Preferably the main direction of the distortion to be expected and the displacement direction of the blade in the blade receiving means coincide. In that way the change in the size of the blade as a consequence of hardening distortion in the hardening operation can be compensated solely by the variation in position of the second point of the blade relative to the blade receiving means.

The blade can be arranged held freely in the blade receiving means in respect of those narrow sides. As the blade, held at the two points in the receiving means, can be mounted non-displaceably with respect to the blade plane in the blade receiving means it is possible for the blade to be held spaced with respect to its narrow sides in relation to walls of the receiving means. That is advantageous in particular in relation to its cutting edge which is usually arranged at a narrow side as its cutting edge remains non-loaded in the blade receiving means by virtue of that feature and thus cannot lose anything of its sharpness.

Preferably the points are spaced from each other with respect to the blade plane at a first spacing parallel to the displacement direction and at a second spacing perpendicularly to the second spacing. In that case the second spacing is equal to the above-described shortest spacing.

The greater the first spacing, the correspondingly less is the lever inclined relative to the displacement direction. In addition the lever is thereby correspondingly lengthened. Both mean that the forces which are transmitted in the second point and which thus cause wear in the mounting in the second point are reduced.

If the lever force transmitted by way of the lever points exactly in the displacement direction, that is to say the first spacing is equal to zero, then the force component pointing perpendicularly to the displacement direction is equal to zero in order however, the same as a sine function, to already become greater than zero upon minimal rotation of the blade about the first point, and thereby to fix the blade at the points.

In a structurally simple fashion the blade can be held in positively locking relationship with respect to the blade plane in the first point. The blade can be held in positively locking relationship in the second point perpendicularly to the displacement direction and thus in the direction of the second spacing.

Also in structurally simple fashion in a development of the knife the blade can be respectively held at the points by means of a plug-in and/or latching connection.

For holding the blade the blade receiving means can have at the two points a respective projection which preferably engages perpendicularly to the blade plane into an associated opening provided on the blade. In this case the projection or projections can each engage through the respectively associated opening. Such engagement of the projection or projections through the opening can be to such an extent that the projection or projections respectively engages or engage at the end into a recess in the blade receiving means, forming a plug-in or latching connection.

In a development of the knife the opening associated with the second point can be in the form of a guide, preferably a linear guide. For that purpose that opening can be in the form of a first slot.

The first slot can be of a first diameter d1 in the longitudinal direction and a second diameter d2 transversely relative to the longitudinal direction, the first diameter d1 being larger than the second diameter d2. The ratio of the first diameter to the second diameter can thus be greater than 1. In particular the ratio can be of a value in a range of 1.01<d1/d2<2.0 and more, preferably 1.1<d1/d2<1.4 or ideally 1.15<d1/d2<1.2. This proposes relatively low ratios which are primarily aimed at compensating for possible hardening distortion of the blade. It will be appreciated that the ratios can also be adapted to compensate for further dimensional deviations like for example excessively large tolerances or construction errors.

The first slot can be of an open configuration at an end in opposite relationship to the displacement direction. Thus the first slot can also be in the form of a lateral slit extending in the displacement direction. That can facilitate inserting the blade into the blade receiving means.

In a further simplification of the knife the projections can each be in the form of a peg of round, preferably circular cross-section. The opening associated with the first point can be in the form of an opening which is congruent in shape with the peg, in particular in the form of a circular opening. The consequence of this is that the peg associated with the first opening can bear with its cylindrical surface, that is to say peripherally radially outwardly, against the associated opening. That measure can reduce possible wear in the transmission of force between blade and peg. Particularly when the housing with the pegs is made from a softer material than the material of the blade it is advantageous, to reduce the wear of the peg in the slot, for same not to be of an entirely circularly round configuration so that the peg does not bear against the slot at the inside thereof in linear relationship but over a narrow surface.

After passing through the opening associated with the respective peg the pegs can latch in preferably spring-loaded fashion behind the opening, for example at the edge of the opening. In that way it is possible to make a plug-in and latching connection between the blade and the blade receiving means. That has the advantage that the blade can be held in surface contact only at a contact surface instead of being held clamped at both sides between two contact surfaces, as is usual.

In a further embodiment of the knife the blade can have a second slot. The second slot can be arranged in mirror symmetrical relationship with respect to the first slot in relation to a plane of mirror symmetry which extends perpendicularly to the displacement direction and in particular contains the second point. In addition that second slot can be of a mirror symmetrical configuration with respect to that plane of mirror symmetry. As a result the blade can be held in two slots and thus in total at three points. Those three points can thus be arranged in a symmetrical triangle. That measure can provide that the positional stability of the blade in the blade receiving means can be enhanced.

Preferably the plane of symmetry at the same time forms the transverse center line of the blade and/or the blade receiving means in the region in which the blade bears at least with one of its flat side surfaces. In that way the blade can be fitted into and used in the blade receiving means in two fitment positions displaced through 180°. In the case of a usual trapezoidal blade which can also be used here, with a cutting edge parallel to the displacement direction, the cutting edge forms in and in opposite relationship to the displacement direction a respective cutting corner, of which a respective one can project in cuttingly effective relationship out of the blade receiving means in one of the two insertion positions, in the displacement direction.

With respect to the first longitudinal opening, the peg bears against the longitudinal opening at the inside by way of two line-shaped regions which are axial with respect to a peg axis, whereby wear of the peg in those line-like regions can be increased.

The blade receiving means can have a respective peg for the two slots. The therefore two pegs can be arranged in mirror symmetrical relationship the same as the slots. In that way the blade can be held in both slots by the two associated pegs. With the additional peg the number of axial line-shaped regions is doubled whereby it is possible to correspondingly reduce possible wear of the pegs in the slots. In addition the positional stability of the blade in the blade receiving means can be enhanced by the additional peg.

In a further embodiment of the knife in relation to the first and the second points, there can be provided a further first point and a further second point, wherein those points are arranged in mirror symmetrical relationship with a further plane of mirror symmetry, perpendicularly to the above-mentioned planes of mirror symmetry. That further plane of mirror symmetry can be arranged at half the height of the shortest spacing, to save space. In that way a blade having two parallel blade portions can be fitted into the blade receiving means in a position of being turned through 180°, for example after the one cutting edge has worn, to use the other cutting edge. In a combination of both the above-described embodiments there can be a second slot in the third point and three further points in mirror symmetrical relationship with respect to the further plane of mirror symmetry. In that way a blade having two parallel cutting edges can be fitted into the knife in operative cutting relationship in a total of four insertion positions.

For a knife according to one of the embodiments described hereinbefore or hereinafter, it is possible to provide a blade which is adapted to be held in non-displaceable relationship at the first point and displaceably at the second point in a displacement direction, in a blade receiving means of the knife, in relation to the blade plane. For that purpose the shortest spacing of the displacement direction relative to the first point can be greater than zero. For fixing in the blade receiving means at the first point the blade can have a round, in particular circular first opening and in the second point an opening which is in the form of a first slot longitudinally extending in the displacement direction.

In a development the first slot of the blade can be laterally opened at one side in the displacement direction. In that way the slot can be of a slit-like shape.

The blade can have a second slot which is arranged in mirror symmetrical relationship with the first slot in relation to a plane of mirror symmetry which extends perpendicularly to the displacement direction and contains the second point. The second slot can be arranged in mirror symmetrical relationship with the first slot in relation to that plane of mirror symmetry. The second slot can also be of a slit-like configuration.

### BRIEF DESCRIPTION OF THE DRAWINGS

The present invention is described in greater detail herein by means of an embodiment of the knife and the blade illustrated in a drawing in which:

FIG. 1 shows a plan view of a first embodiment of a knife with blade receiving means and inserted blade, with the blade receiving means being opened;

FIG. 2 shows an individual view of the blade illustrated in FIG. 1;

FIG. 3 shows an individual view of the blade receiving means shown in FIG. 1 with peg;

FIG. 4 shows an individual view of the blade receiving means shown in FIG. 3, but with an additional peg;

FIG. 5 shows an individual view of the blade shown in FIG. 1 with inserted peg; and

FIG. 6 shows an individual view of a further embodiment of the blade.

### DETAILED DESCRIPTION

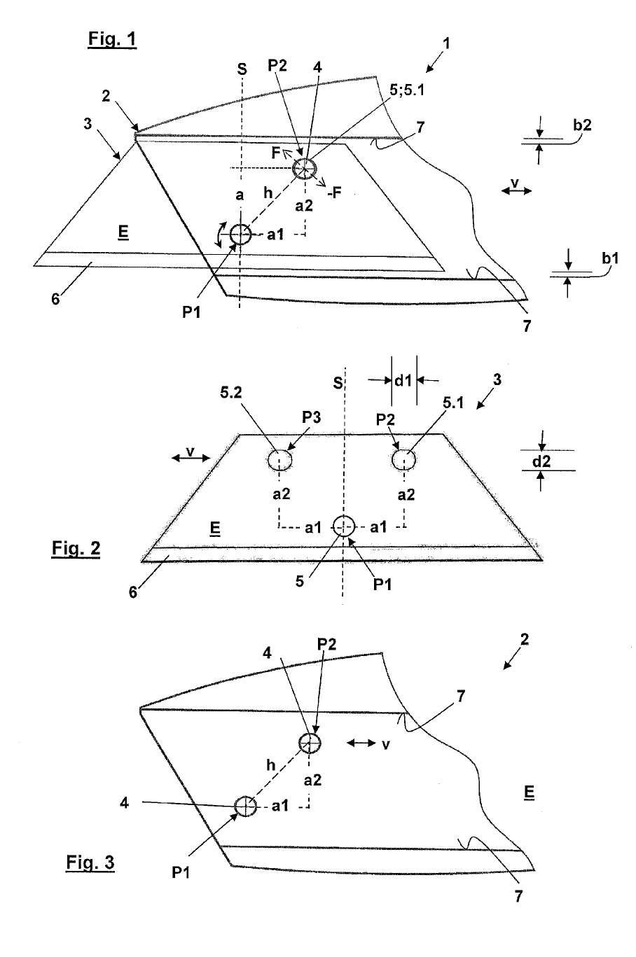

FIG. 1 shows a plan view of a first embodiment of a knife 1 with a blade receiving means 2 and a blade 3. The blade 3 is flat with a blade plane E which is the same as the plane of the drawing in the Figures. Of the knife 1 only the region of the blade receiving means 2 is shown as other regions of the knife 1 are not relevant to the invention. In addition the contour of the blade receiving means 2 is to be taken only by way of example as it can also be of any other configuration. The blade receiving means 2 is shown in the open condition for the sake of clearer illustration. The blade receiving means 2 shown here is formed by two housing halves of which only one housing half 2.1 is shown, being the lower half here, wherein the blade 3 bears in surface contact against the housing halves 2.1 in the blade receiving means 2. FIGS. 2 through 5 show individual views of the blade 3 and the blade receiving means 2.

The blade 3 is held non-displaceably in the blade receiving means 2 at two mutually spaced points, that is to say, at a first point P1 and a second point P2, with respect to the blade plane E. In this case the blade 3 is held non-displaceably at the first point P1 in relation to the blade plane E and is held displaceably at the second point P2 in a displacement direction v. In regard to the blade plane E in this case the shortest spacing a of the displacement direction v passing through the second point P2, in relation to the first point P1, is greater than zero.

The points P1, P2 are spaced from each other in relation to the blade plane E at a first spacing a1 parallel to the displacement direction v and at a second spacing a2 perpendicularly to the first spacing a1, the second spacing a2 being equal to the shortest spacing a. The blade 3 is held in the first point P1 in positively locking relationship with respect to the blade plane E and in positively locking relationship in the second point P2 perpendicularly to the displacement direction v and thus in the direction of the second spacing a2. As a result a fixed lever h extending between the two points P1, P2 is formed (see FIGS. 1, 3 and 4), by way of which the blade 3 is held non-displaceably and non-rotatably in the blade receiving means 2. With the first point P1 as a pivot point, by way of the lever h, a lever force F and −F respectively is exerted with a force component perpendicularly to the displacement direction v on the blade 3, which presses the blade perpendicularly to the displacement direction v at the inward side against the wall of the slot 5.1 whereby the blade 3 is held non-rotatably in the first point P1.

At the two points P1 and P2 the blade receiving means 2 of FIGS. 1 and 3 has a respective projection here in the form of a pin or peg 4 of circular cross-section which engages into a corresponding opening 5 of the blade 3, forming a plugging connection, perpendicular to the blade plane E. The opening 5 associated with the first point P1 is of the same cross-section as the peg 4 whereby the blade 3 is fixed in positively locking relationship in the point P1 at the blade receiving means 2. The drawing does not show, although this is provided here, that the pegs 4 engage into a recess provided on the other housing half (not shown here), passing through the openings 5 and forming a plugging connection.

The opening associated with the second point P2 is in the form of a first slot 5.1 which extends longitudinally in the displacement direction v. It is of a first diameter d1 in the displacement direction v and of a second diameter d2 transversely to the displacement direction v. The difference between the two diameters d1, d2 defines a travel distance over which the blade 3 can be displaced in the displacement direction v relative to the peg 4. Since, as stated hereinbefore, a hardening distortion of the blade 3, that is to be compensated here, is some tenths of a millimeter, the first diameter d1 is only somewhat larger than the second diameter d2, wherein the ratio of the two diameters d1/d2 is here about 1.16, purely by way of example.

In all embodiments shown here the blade 3 has a second slot 5.2 which is of an arrangement and configuration in mirror symmetrical relationship with the first slot 5.1, relative to a plane S of mirror symmetry which extends perpendicularly to the displacement direction v and which contains the second point P2. The second slot 5.2 is in alignment with the first slot and is disposed at double the first spacing al relative to the first slot 5.1.

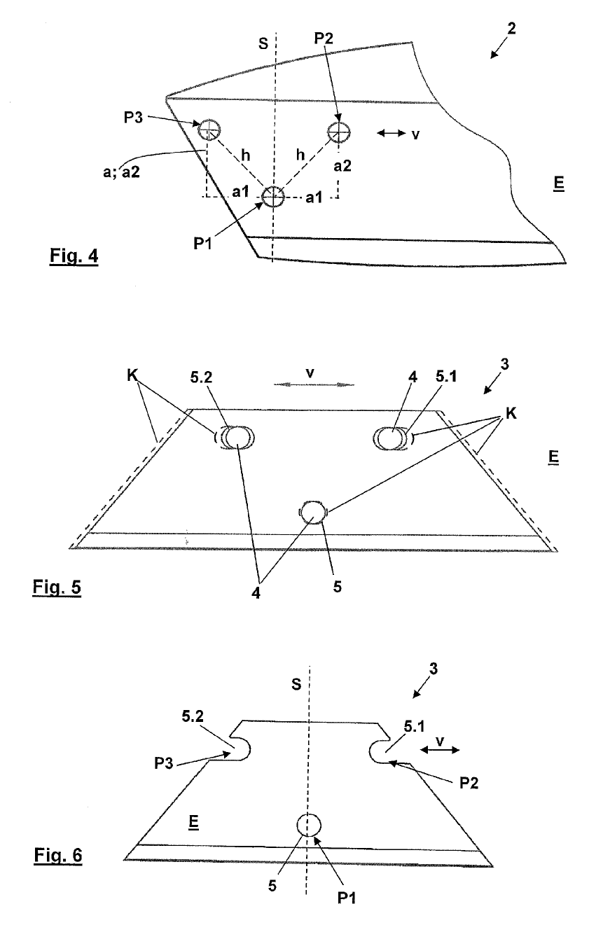

In corresponding fashion the blade receiving means 2 of FIG. 4 has at a third point P3 an additional peg 4 which is of a configuration and arrangement in mirror symmetrical relationship with the peg 4 associated with the second point P2, in relation to the plane E of mirror symmetry. In that way the blade 3 is held at three points P1-P3, wherein those points P1-P3 are arranged in an isosceles triangle in relation to the first point P1. That means that the blade 3 is mechanically stably held. Mechanically favorable symmetrical force conditions with two levers h arranged in mirror symmetrical relationship prevail, which levers form a stable force triangle and which act with displacement of the blade 3 synchronously thereon. In the case of hardening distortion which is uniform over the displacement direction v of the blade 3, with shrinkage, the levers h engage into the slots, being displaced from the plane of symmetry E.

FIG. 5 shows an individual view of the blade 3 with inserted pegs 4, to show in purely qualitative fashion the substantial changes in dimensions as a consequence of hardening distortion, wherein in particular the dimensional changes are shown in greatly exaggerated form for the sake of enhanced clarity, that is to say greater by a multiple than the dimensional changes which actually occur. The original body lines K of the blade 3 and thus the hardening distortion which occurs are shown in broken line. As can be seen from FIG. 6, in relation to the blade plane E, the axial distortion of the blade strip from which the blades are stamped out is markedly greater than the distortion perpendicularly thereto. That axial distortion is completely compensated by the peg 4 engaging in suitably displaced relationship in the displacement direction in the second point P2 into the first slot 5.1 (and, as shown in FIGS. 2 and 4, into the second slot 5.2).

FIG. 6 shows a further embodiment of the blade 3 in which the two slots 5.1, 5.2 are laterally opened in the displacement direction v and are thus of a slit-like configuration. This embodiment allows easier and more secure insertion of the blade 3 into the blade receiving means 2.

Going back to FIG. 1, it can be clearly seen therefrom that it is possible, by virtue of the stable hold for the blade 3, for the cutting portion 6 of the blade 3 to be arranged at a first gap b1 in relation to the wall 7 adjacent thereto of the blade receiving means 2. This means that the cutting portion 6 with its cutting edge (which is not specifically shown here) is not to be disadvantageously mechanically loaded by bearing against the wall 7. The blade 3 is also arranged spaced upwardly in relation to the wall 7 adjacent thereto of the blade receiving means at a second gap b2, wherein the two gaps b1, b2 are here about the same in width. That measure makes it possible for certain dimensional tolerances of the blade receiving means and/or the blade transversely relative to the cutting edge to be also compensated without any problem.

### LIST OF REFERENCES

1 knife
2 blade receiving means
2.1 lower housing half
3 blade
4 peg
5 opening
5.1 first slot
5.2 second slot
6 cutting portion
7 wall
a shortest spacing
a1 first spacing
a2 second spacing
b1 first gap
b2 second gap
d1 first diameter
d2 second diameter
h lever
v displacement direction
E blade plane
K body line
P1 first point
P2 second point
P3 third point

What is claimed is:

1. A knife comprising:
a blade receiving means and a blade having a blade plane,
wherein the blade is held in the blade receiving means at two mutually spaced points providing a first point and a second point,
wherein the blade is held with respect to the blade plane non-displaceably at the first point and displaceably in a displacement direction at the second, and
wherein a shortest spacing of the displacement direction passing through the second point relative to the first point is greater than zero.

2. The knife as set forth in claim 1, wherein the first and second points are spaced from each other with respect to the blade plane at a first spacing parallel to the displacement direction and at a second spacing perpendicular to the second spacing.

3. The knife as set forth in claim 2, wherein the blade is held with respect to the blade plane in a positively locking relationship in the first point and in a positively locking relationship perpendicular to the displacement direction in the second point.

4. The knife as set forth in claim 1, wherein the blade is held at the first and second points by a respective push-in and latching connection.

5. The knife as set forth in claim 1, wherein at the first and second points the blade receiving means has a respective projection which engages through an associated opening provided on the blade.

6. The knife as set forth in claim 5, wherein the opening associated with the second point is in the form of a first slot.

7. The knife as set forth in claim 6, wherein the first slot is of a first diameter (d1) in the displacement direction and a second diameter (d2) transversely relative to the displacement direction and the ratio of the first diameter (d1) to the second diameter (d2) has a value in a range of 1.05≦d1/d2≦2.0.

8. The knife as set forth in claim 6, wherein the first slot is of an open configuration at an end in opposite relationship to the displacement direction.

9. The knife as set forth in claim 5, wherein the projections are respectively in the form of round pegs and the opening associated with the first point is in a form which is congruent in shape with the peg.

10. The knife as set forth in claim 6, wherein the blade has a second slot having an arrangement and configuration in mirror symmetrical relationship with the first slot with respect to a plane of mirror symmetry which extends perpendicular to the displacement direction and contains the second point.

11. A blade for a knife having a blade receiving means comprising:
the blade holdable in the blade receiving means with respect to a blade plane non-displaceably at a first point and displaceably in a displacement direction at a second point and a shortest spacing of the displacement direction relative to the first point is greater than zero, and wherein in the first point the blade has a round first opening and in the second point the blade has an opening which is in a form of a first slot extending longitudinally in the displacement direction.

12. The blade as set forth in claim 11, wherein the first slot is of an opened configuration towards one side in opposite relationship to the displacement direction.

13. The blade as set forth in claim 11, wherein the blade has a second slot which is of an arrangement and configuration in mirror symmetrical relationship with the first slot with respect to a plane of mirror symmetry which extends perpendicular to the displacement direction and contains the second point.

14. The knife as set forth in claim 7, wherein the value of the ratio of the first diameter (d1) to the second diameter (d2) is in a range of 1.1≦d1/d2≦1.4.

15. The knife as set forth in claim 7, wherein the value of the ratio of the first diameter (d1) to the second diameter (d2) is in a range of 1.15≦d1/d2≦1.2.

16. The knife as set forth in claim 9, wherein the round pegs are of circular cross-section and the opening of the first point is a circular opening.
